(19) United States
(12) Patent Application Publication
(10) Pub. No.: US 2009/0204921 A1
(43) Pub. Date: Aug. 13, 2009

(54) System and Method for Organizing, Managing, and Using Electronic Files

(76) Inventor: Anthony R. Vestyck, Plains, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/367,805

(22) Filed: Feb. 9, 2009

Related U.S. Application Data
(60) Provisional application No. 61/027,033, filed on Feb. 7, 2008.

(51) Int. Cl. G06F 3/048

(52) U.S. Cl. 715/769

(57) ABSTRACT

A system for organizing information resources electronically, preferably in the context of a lesson plan is disclosed. The system also provides a simple, clean, easy-to-use interface that creates a dynamic structure for storing document and other information files and for presenting the user with an easy method to retrieve and use the files. A preferred embodiment of the system according to the present invention allows teachers to visually assess the quality of their lesson plan(s) as created and utilized, to apply templates to standardize the teaching of students across multiple educators, and to provide reports on demand that provide details on the effectiveness and comprehensiveness of their lesson plans. At the same time, the system is flexible enough to allow educators to customize their lessons to meet individual students' needs.

### CROSS-REFERENCE TO RELATED APPLICATION

This application claims the benefit of U.S. Provisional Application No. 61/027,033 filed Feb. 7, 2008, the entire disclosure of which is incorporated herein by reference.

### BACKGROUND OF THE INVENTION

1. Field of the Invention

This invention relates to electronic systems for organizing, managing, and using document files. More specifically, the invention relates to an electronic tool for helping educators store in a central location files utilized in their curriculum. The invention also relates to techniques for dynamically creating file structures to store computer files based on input from the user.

2. Description of the Related Art

One of the greatest challenges educators face is the proper organization and management of their educational materials. Teachers are often placed in charge of teaching multiple subjects to multiple groups of students. Unfortunately, paper can take up a significant portion of the teacher's available classroom space, and a teacher may waste valuable time searching through hard copies of documents for information. Paper copies of documents can be expensive for the school, and paper printouts may be wasted if the teacher finds it necessary to change the curriculum to meet the needs of the students.

Computers have the capability to alleviate some of this burden. Thousands of searchable electronic documents can fit on a small thumb drive. Networks allow for nearly instantaneous transfer of documents between people. However, some educators have been teaching for over 40 years, and many are anxious about the idea of transferring the bulk of their work to an unfamiliar system such as a computer. They may believe that since their current system has worked so far, learning a new system would be unproductive. Given the myriad of electronic options currently available to educators, it is no wonder they are hesitant to adopt such systems. The known systems are often extremely complex, and may require computer skills that many educators do not possess, such as accessing the Internet or uploading files to or from a server. Consequently, many teachers are ill-equipped to integrate computers into their curriculums.

Unfortunately, this results in the teachers missing many opportunities to incorporate novel teaching materials into their lesson plans. The Internet hosts a vast number of resources that can be used to support education. Video clips, images, documents, and sound files are some of the many types of materials that are available online and could aid in teaching students. However, organizing them can be difficult, and easily retrieving them is often difficult for a teacher without sufficient experience with computerized systems.

### BRIEF SUMMARY OF THE INVENTION

The present invention provides a system for organizing information resources electronically, preferably in the context of a lesson plan. The invention also provides a simple, clean, easy-to-use interface that creates a dynamic structure for storing document and other information files and for presenting the user with an easy method to retrieve and use the files. A system according to the present invention allows teachers to visually assess the quality of their lesson plan(s) as created and utilized, to apply templates to standardize the teaching of students across multiple educators, and to provide reports on demand that provide details on the effectiveness and comprehensiveness of their lesson plans. At the same time, the system is flexible enough to allow educators to customize their lessons to meet individual students' needs.

### BRIEF DESCRIPTION OF THE SEVERAL VIEWS OF THE DRAWINGS

The foregoing summary, as well as the following detailed description, will be understood more clearly when read with reference to the drawings, wherein:

FIG. 1 is a logical flow diagram demonstrating the steps involved in using a program in accordance with the present invention;

FIG. 2 is a screenshot of a matrix display that is presented to a user when operating a preferred embodiment of a system according to this invention;

FIG. 3 is a screenshot of a calendar that is displayed to a user;

FIG. 4 is a screenshot of a graphical display of two sets of assigned standards for an exemplary course;

FIG. 5 is a screenshot of a textual display of standards assigned for each of three exemplary courses;

FIG. 6 is a screenshot of a dialog box used to set up the matrix in the system according to the present invention;

FIG. 7 is screenshot of another dialog box used to set up the matrix in the system according to the present invention;

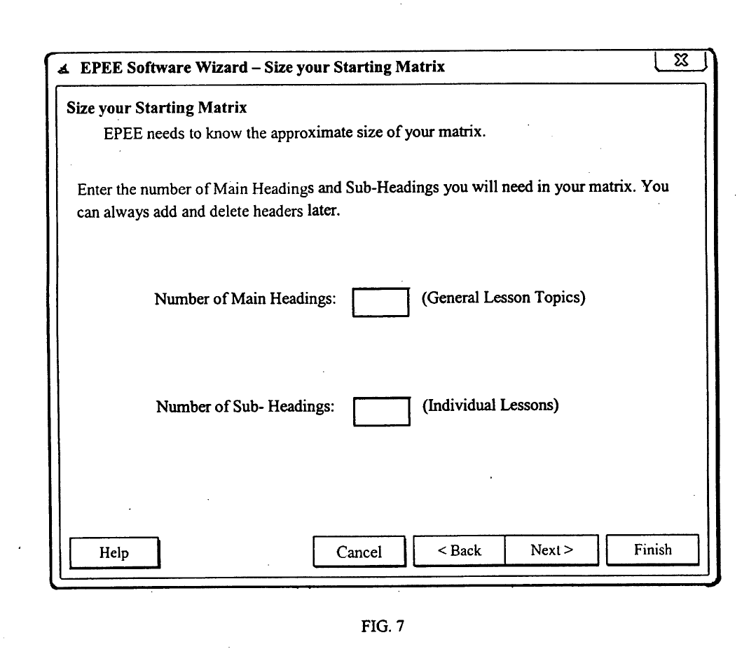

FIG. 8 is a screenshot of a third dialog box used to set up the matrix in the system according to the present invention;

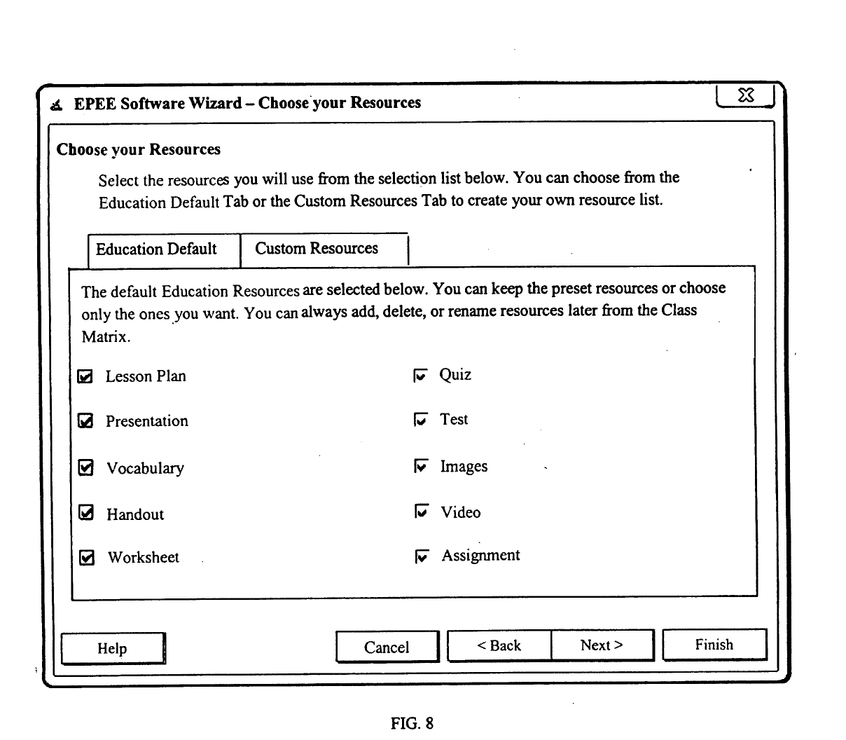

FIG. 9 is a screenshot of a fourth dialog box used to set up the matrix in the system according to the present invention;

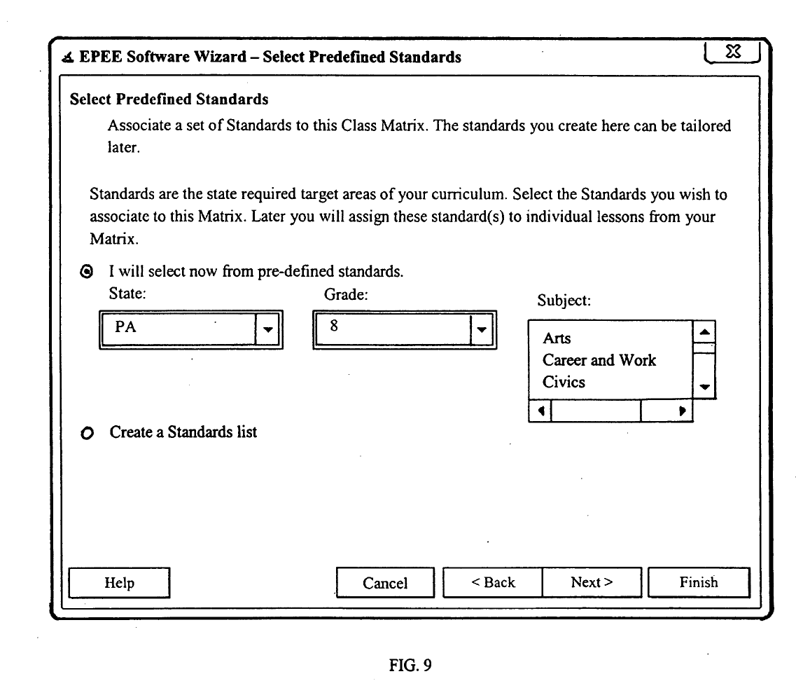

FIG. 10 is a screenshot of a fifth dialog box used to set up the matrix in the system according to the present invention;

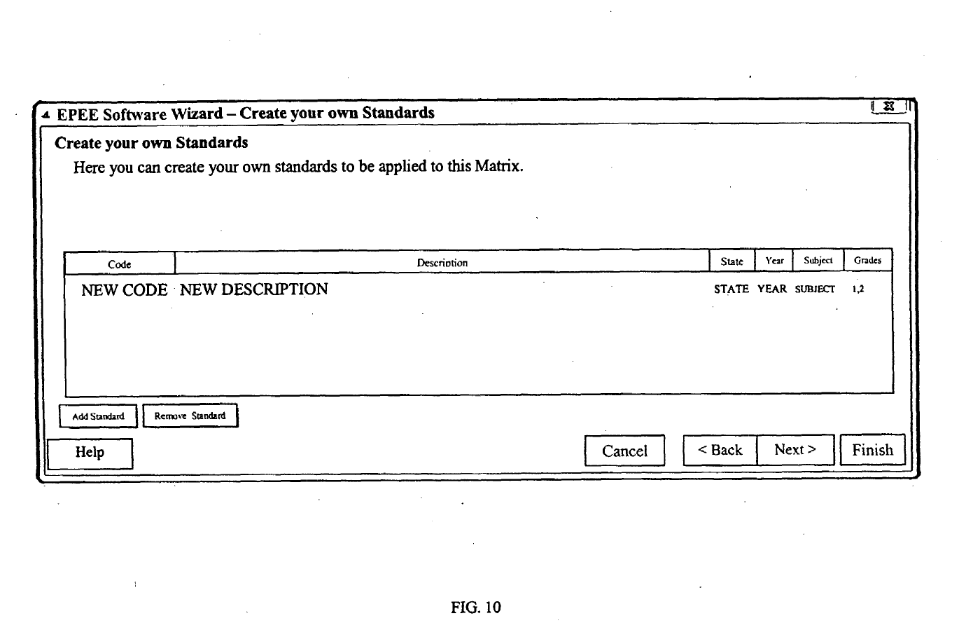

FIG. 11 is a screenshot of a further dialog box used to set up the matrix in the system according to the present invention; and

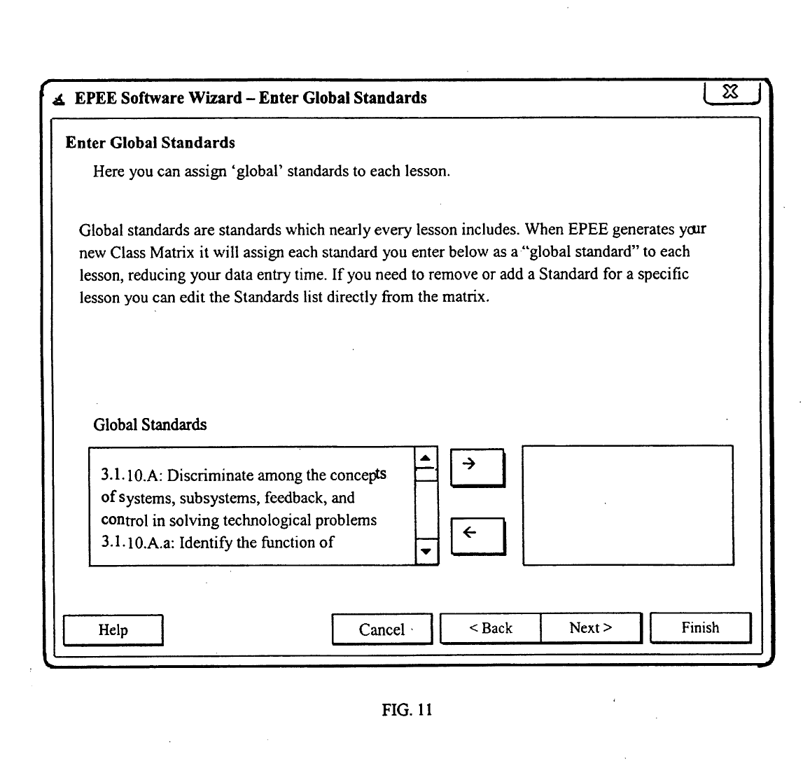

FIG. 12 is a screenshot of a standards association dialog box, used in the system of the present invention.

### DETAILED DESCRIPTION

In accordance with a preferred embodiment of the invention, there is provided a system for capturing and organizing files used in support of an educational curriculum. The system includes a program stored on a computer-readable storage medium. During execution, the program presents a user with an interface preferably containing a plurality of cells in a matrix or tabular format. The system provides means for a user to associate particular files with respective ones of the cells, including the “drag and drop” technique. When a file is dragged onto a cell, the program automatically creates a duplicate copy of the file to be stored in a file structure, so as to prevent any changes or accidental deletion from adversely affecting the original file. The system guides the user through the steps of creating column headings (headers) that help the user determine what kind of file is associated with the cells of the column, and row headers that help the user determine which matter the files pertain to. In an education-related embodiment of the system, the matter would be a lesson. The matrix presented to the user can then be used in a method of interfacing with the copied files. Users can print and access their files from the matrix. In this way, the user is presented with a quick and easy method of organizing and accessing the files.

Cells that have files associated with them preferably provide indicia to the user relating to the status of the files. In a preferred embodiment, the indicia may comprise the use of color. Other types of indicia such as alpha-numerical character strings, symbols, color changes, codes, dates, and the like could be used. Users can then mark cells that have files associated with them as “complete.” For example, cells that contain files of completed goals are marked as complete by a color indication in the cells. In this way, a user can keep track of which cells have content associated with them, and what content has already been utilized.

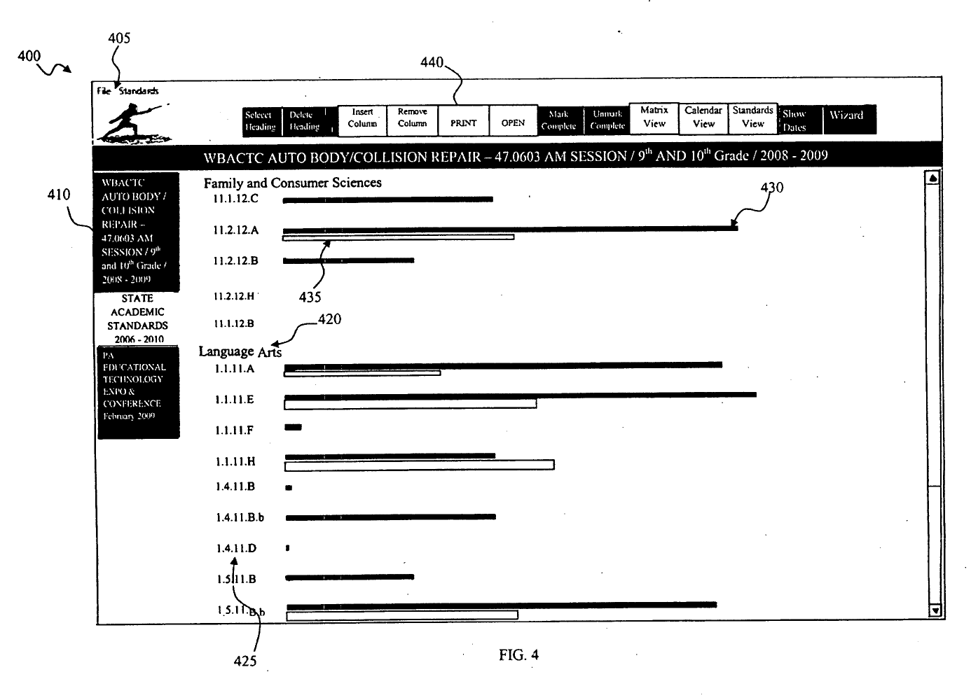

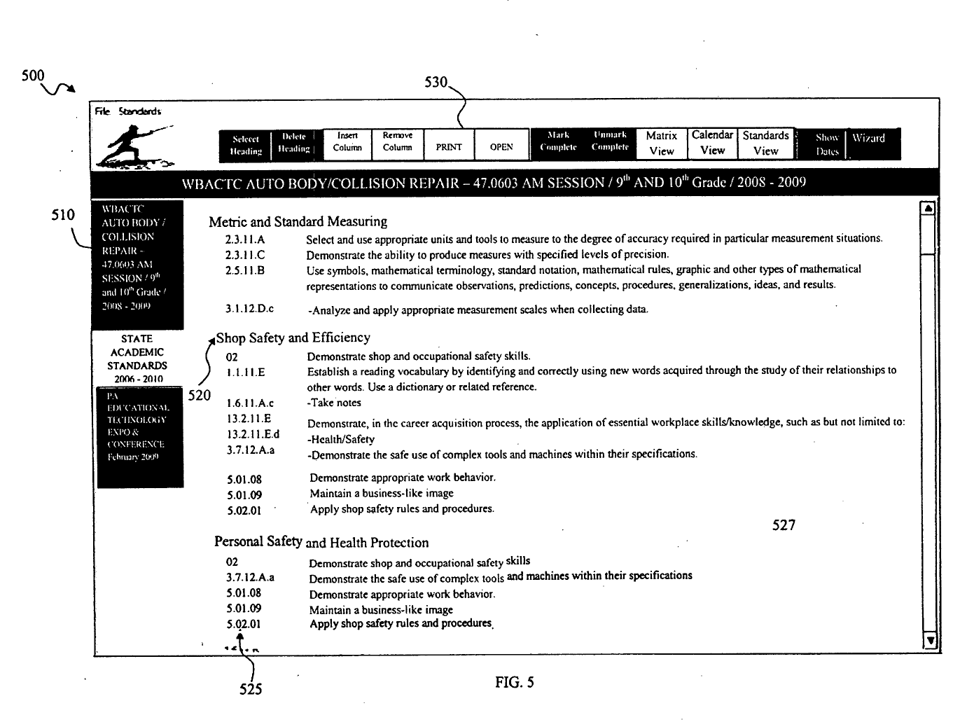

Standards of education must be maintained in order to maximize student learning and potential. In an education-related embodiment of the system according to the invention a method of associating standards to the rows of the matrix is provided. In the preferred embodiment, these standards may take the form of educational standards. Educational standards are milestones defined in some way that determine if a student or class has been taught properly in a subject. A preferred embodiment of the invention allows a user to define his or her own standards or utilize a pre-loaded list of standards provided by school district or state educational authorities. These standards can then be used as guidelines for the user's curriculum. Standards can be updated if they change and automatically loaded into the system in the proper file format. The system provides quick views of standards in both a graphical representation, as shown in FIG. 4, and a textual summary, as shown in FIG. 5. The standards displays are designed to allow the teacher to quickly gauge how well they are meeting the mandated or desired standards.

Evaluation of an educational curriculum allows a teacher to see how effective his or her teaching methods are. For this reason, the system can also permit a teacher to evaluate his/her curriculum against a predefined benchmark. Cells can be assigned values that will be tallied when the content files are associated with the cells. In the preferred embodiment, this will allow a teacher to constantly compare his or her curriculum, as organized by the program, against a mandated or desired standard. This regular, continuous, and automatic evaluation can provide parents, teachers, and administrators with timely information on the quality of education being provided to the students.

The system according to the present invention includes a computerized step-by-step process for creating the matrix that takes the highly technical aspect of the invention out of the hands of the teachers and presents it in an easy to use manner. In the preferred embodiment, the user is shown a series of dialog boxes and corresponding instructions for each box, in a step-by-step process.

The system also provides a calendar view of the students' progress to date. It shows in a calendar all files associated with a cell that are marked as complete. This allows teachers to see their teaching history, what lessons were covered on what day, and what material was used along with it. That information permits a teacher to plan more effectively for future lessons and to determine what lessons were effective and which were not.

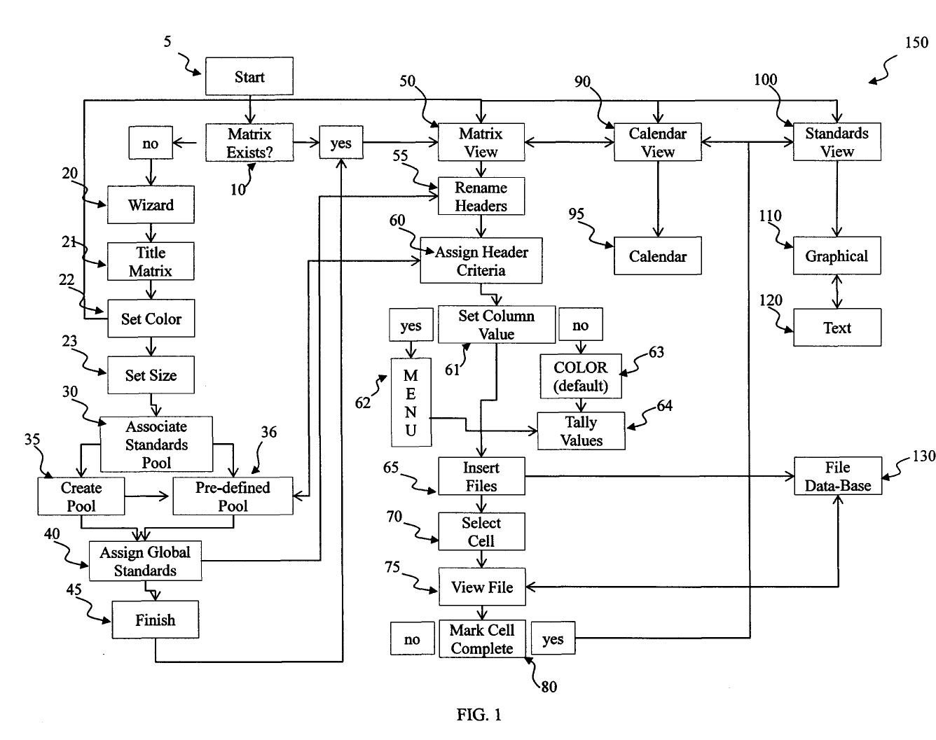

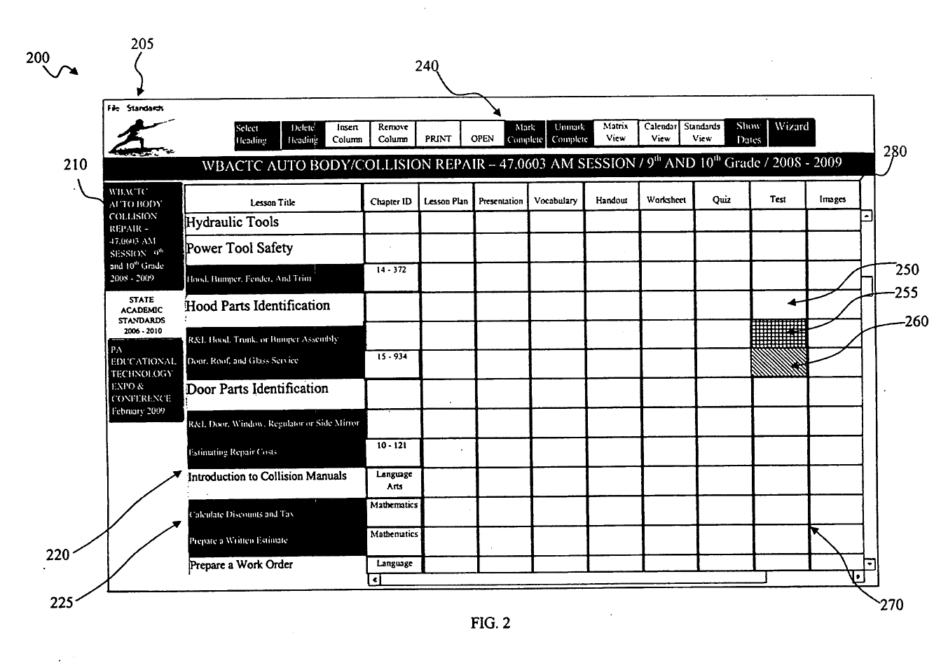

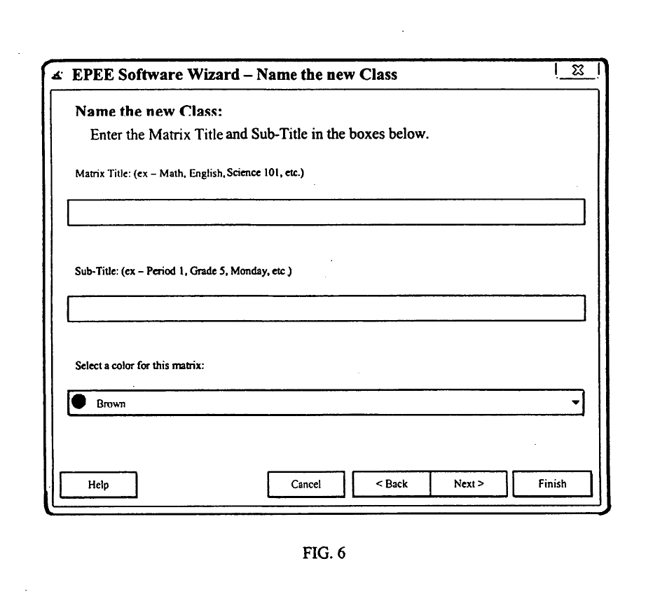

A preferred method according to the present invention will now be described with reference to the figures. Although the preferred embodiment is described in the context of an educational application, other applications for the concepts utilized in the described system will be apparent to those skilled in the art. Referring now to FIG. 1, a system 150 includes a software program located on a computer-readable storage medium, activated by the user, for example, a teacher who wants to organize his or her curriculum. The software is designed to help the user organize his or her files, such as a lesson plan and supporting multimedia files. When the program is activated at step 5, it first moves to step 10 and determines if a matrix has already been created by or for the user. A matrix is defined in this specification as a plurality of cells arranged in rows and columns that are created by the software in order to help the user organize his or her files. If a matrix already exists, the user is taken to a Matrix View subprogram 50. If the matrix does not already exist, a Setup Wizard subprogram 20 is called. In the Setup Wizard subprogram, the user can create a Main Title and Subtitle for the matrix in step 21 using a dialog box as shown in FIG. 6. The user can also set the color for the title bar and selection tab of the matrix in step 22. The number of headers and the types of columns are selected in step 23. For the purposes of this software, a header is defined as the name of a row of the matrix. The user can select the size of the matrix from a list of presets or create a custom combination of rows and columns. In step 30, the user is prompted to create a set of standards for the curriculum. The standards define goals to be accomplished during a course, such as concepts the teacher wishes to teach the students. The standards can either be defined by the user at step 35, or they can be selected at step 36 from sets of predefined standards programmed into the system. Once in matrix view (FIG. 2), the user can assign these standards to specific lessons. After creating the list of standards, the user is prompted to select global standards at step 40. Global standards are those standards that will apply to every header, such as the use of a particular document, text, graphic, or a common assignment that will be given at the end of every section. Global standards remove extra steps a teacher would otherwise have to take to utilize a common resource in every section. In step 45, the user completes the Setup Wizard and the program generates the matrix.

When the system creates the matrix, it also creates a file used to store descriptions of the matrix and all the files associated with it. This file, which could preferably be named “hypermatrix.dat”, is created by the system to describe all of the features of the matrix, including the number of rows and columns, the headings, and all the standards and files associated with the matrix. The system also creates another file, preferably named “user_prefs.dat”, to store information about the user such as the system preferences and licensing information.

Upon creation of the matrix, the user is taken to the Matrix View subprogram 50. This subprogram presents the user with the matrix, which consists of the columns and rows defined in the Wizard. In this part of the program, a user can perform a number of functions. At step 55, the user can rename headers (to refine the topics covered in the lesson plan, for example) by right clicking on them. Right-clicking on the header also gives the user the ability to change colors and insert or delete a row. The user can also assign new header standards at step 60 by right clicking on respective header. At step 61, the user can right click a Column Header to set a value that will be attached to every cell in the column. The value is preferably a color, which is the default value selected in step 63. Alternatively, the value can be a numerical value.

The values set for each column are preferably used to tally the curriculum's matrix score of the data stored in the matrix. In step 64, a matrix score or tally value is generated that can be used to evaluate the contents of the matrix against some reference value, such as a national standard. The tally value is calculated by tallying the assigned weight of each cell (by default, all cells hold equal weight, but this can be changed by the user) and determining if the cell has an associated file and if it has been completed. The tally value can be used as an indicator to determine if the curriculum stored in the matrix is meeting a minimum standard of education for the students.

The user can also insert files into the matrix at step 65. Various methods are possible, but the preferred method is to “drag-and-drop” files from the computer's folders into the matrix cell directly. This is the easiest and most intuitive method, and allows people unfamiliar with technology to quickly learn how to use the system. When the files are inserted, they are copied to file database 130 and the value of the cell is changed to indicate that a file is associated with the cell. The cell also becomes a link to the file. Selecting the cell (or cells—the system allows for multiple selections) at step 70 allows users to view or print files. Double-clicking a cell opens the file associated with the cell. The system retrieves the file from file database 130 and displays it on the computer.

These associated files are stored as copies in the “Files” folder of the program. They are renamed with a unique ID, which is referenced in the hypermatrix.dat file. When a file needs to be accessed, it is looked up in the hypermatrix.dat file, and placed in a temporary folder for viewing.

At step 80 the cell can be marked as completed, indicating that the file associated with the cell has been used in the course curriculum. This alters the value of the cell to reflect that it is now completed. The program time-stamps the cell and forwards the cell to the calendar in step 95. The program also re-tallies the cell values and updates the matrix score if necessary.

FIG. 2 is a screenshot depicting a preferred matrix view of the software. Matrix view 200 includes a matrix 270. The matrix view includes a menu 205, a set of tabs 210 for each course or class, a set of headers 220 and subheaders 225 for each lesson, a set of columns 280, and a set of controls 240. The controls 240 are preferably implemented as buttons or links.

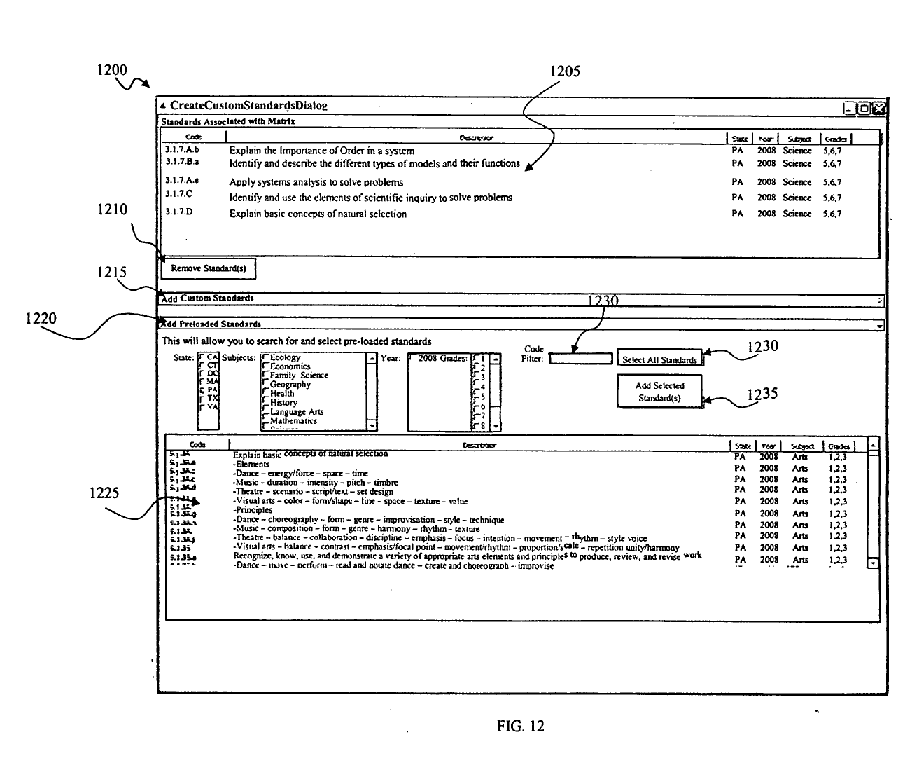

Menu 205 is used to import and export data, save course progress information, or open an “associated standards” dialog box as shown in FIG. 12. Tabs 210 can be clicked on to switch the user between classes. In this way, associated files and standards can be kept separate, and the user is not presented with irrelevant information. The system also has a “duplicate tab” feature. If the user has multiple classes that will be following the same curriculum, the user can create the lesson plan once and then duplicate the tab as many times as necessary. This allows the user to keep progress separated by class, even if using the same materials. Headers 220 and subheaders 225 are defined by the user in the set-up wizard as described above. The headers 220 are used by the user to organize the lessons by some common theme (such as a textbook chapter). The subheaders 225 are used to subdivide the lessons into sections. The columns 280 of the matrix define the categories of materials that are contained in the cells in the respective columns. The columns are defined in the set-up wizard, and can be either created by the user or selected from a list of presets as described above. In this way the various course materials are organized by media type, so that the user can rapidly access the materials for use.

In the matrix view, the user can associate files with each cell in the matrix as described above. Empty cells 250, i.e., cells with no associated content, are uncolored. Dragging and dropping a file onto a cell cause the cell to be marked as filled but incompleted, as illustrated by cell 255. Right-clicking a cell opens a pop-up menu and clicking the selection “mark complete” changes the cell's value, and thus its color, resulting in a completed cell 260. A completed cell can be re-marked as incompleted, by right-clicking on the cell and selecting the appropriate command from the pop-up menu. The same operation can be used to re-mark an incompleted cell as completed.

The matrix view also allows users to assign standards with each user-defined lesson. When the user right-clicks on a lesson header or subheader, another pop-up menu is displayed and the user can then click on the “Standards list” item in the pop-up menu. From there, a list of standards that have been associated with the course are displayed. A user can link one or more of the standards to the lesson files in the matrix. This function allows teachers to remain flexible in their teaching styles while still meeting the state-defined “checklist” of items that students for a particular grade must learn.

The association of vocational lesson plans or curriculum components with mandated standards is known by education authorities as “crosswalk”. A crosswalk ensures that vocational lessons or other curriculum components a teacher has set up adhere to any mandated standards. For example: Two math standards might include: “the students will add and subtract numbers” and “the students will multiply numbers.” In an auto body class, a lesson might be “prepare an estimate on a damaged car.” The auto body teacher can assign these two math standards to the auto body lesson and therefore meet those standards outside the context of a math-specific course.

Sets of standards are stored in files, such as XML files, which can be easily created and added to as necessary. For example, if a state education authority updates their education standards on a yearly basis, it is a simple matter to include the new standards in the system when they are promulgated and to remove the previous set of standards from the system. It will be appreciated that a similar replacement standards replacement can also be done for school-created standards or teacher-created standards. When the system software is executed on a computer, it searches for any standards files that are contained in the system's “Standards” folder and automatically makes those files available to the user.

Control set 240 contains a set of controls for the user. The controls are preferably implemented as a plurality of buttons or links arrayed across the top of the matrix view. The controls allow the user to perform the following functions: insert or delete headers, insert or remove columns, print a file contained in a highlighted cell, open a file contained in a highlighted cell, mark cells as completed or incompleted, or switch between the views generated by the system software. The controls also allow the user to re-activate the set-up wizard, for example, when a user needs to add a new course, or to toggle on or off the displaying of the date/time stamps for completed items.

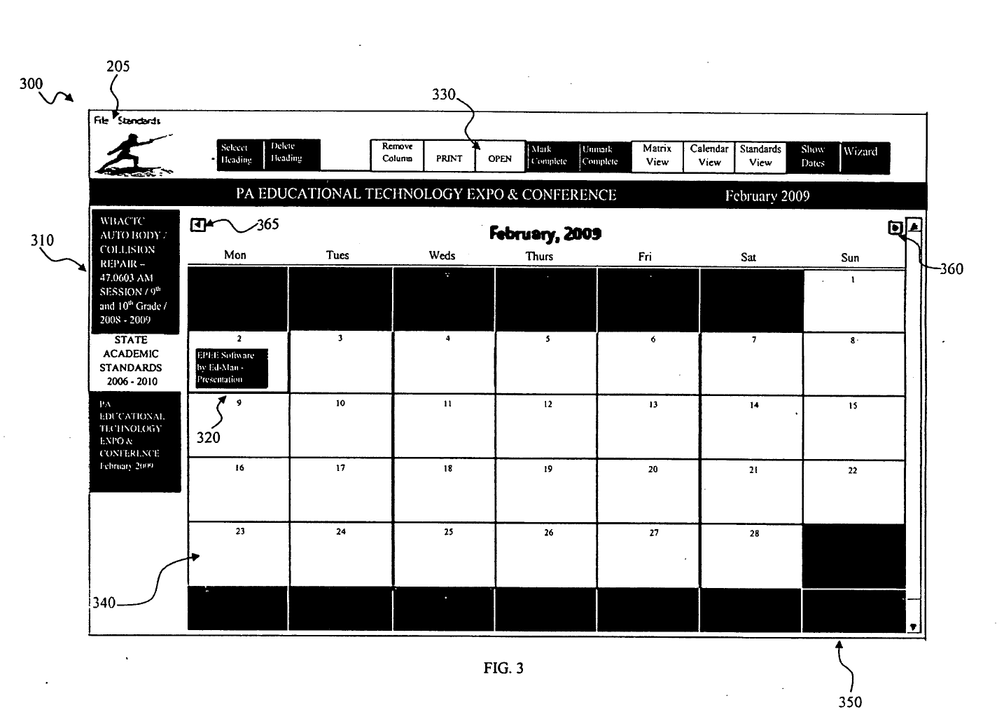

A Calendar View is displayed to the user in step 90. A preferred The Calendar View displays completed cells marked with the dates they were completed. The Calendar View allows the user to view all the work completed in a specified time period. In the embodiment shown in FIG. 3, the time period is a calendar month. However, other time desirable time periods can also be used.

As shown in FIG. 3, Calendar View 300 displays a calendar 350. In the Calendar View screen, the user can see the cells that have been marked as complete. The cells displayed correspond to a time/date stamp generated when a cell is marked as completed. When a cell is marked as completed in the Matrix View, the cell is sent to the calendar, where a text box 320 with the name of the completed material displayed on the date of completion. Any date in which no content is marked as “completed”, such as block 340, is left blank.

The set of tabs 310 is used to switch between classes in the Calendar View. This allows the user to see only information that relates to the class or course they are planning for. Controls 360 and 365 let the user move between the displayed periods for the current class. These controls give a “historical perspective” to the user so that he/she can see past completion dates and the context surrounding the completion of each item in the curriculum for a class.

A control set 330 is provided in the Calendar View that is identical to control set 240 in the Matrix View screen. The control set 330 contains a series of controls for the user. In this example, the control set allows the user to insert or delete headers, insert and remove columns, print the file contained in the currently highlighted cell, open the file contained in the currently highlighted cell, mark cells as complete or incomplete or switch between the various available view screens. The controls also allow the user to re-activate the wizard (such as when a user adds a new class) or toggle displaying of date stamps for completed items.

Calendar View 300 is useful for helping users see their progress. The calendar's tab system helps them keep the information they see contextual, and the presentation on a calendar allows them to see their progress to date at a glance.

Standards view 100 displays all the standards set up by the user at step 30. These standards can be viewed graphically or as a list in text form. All three views can be accessed by clicking the corresponding button in the action bar at the top of each view.

FIG. 4 is a screenshot of a graphical summary 400 of the Standards View that is generated in step 100. The Standards View is used to determine the success of the teacher relative to the educational standards as defined in step 40. The graphical summary 400 includes a menu system 405 that includes pull-down menus for such functions as saving, exporting, importing, exiting, and defining new standards. In addition, tabs 410 are provided for switching between courses. The graphical summary 400 also includes the standard set of controls 440 that are included in the Matrix View and Calendar View for moving between views, printing, activating the set-up wizard, and other functions.

In the graphical summary screen 400, a topic or course identifier 420 is provided so that standards can be grouped by topic. Each topic is used to define a group of standards that relate to a particular course or curriculum component. Every topic has a list 425 of code numbers for the relevant standards for that topic. A description of each standard can be displayed by hovering the cursor over a code number for a standard. Any standards that are not currently assigned to a lesson will be indicated as such (in list 425 unassigned standards are listed in light grey). A standards bar 430 is used to graphically represent the number of lessons in the matrix that include that specific standard, as called for in step 30. A progress bar 435 indicates the amount of progress made in completing associated standards. Every time a lesson plan or curriculum component is completed, the system calculates the number of lesson plans associated with that standard and graphs the percentage of the lesson plans completed. For example, if a standard is associated with 3 lesson plans, the progress bar would increase by 33% every time one of the three lessons is completed (until it matches the length of the standards bar). When standards bar 430 and progress bar 435 are equal in length, the standard has been fulfilled. The number values associated with either standards bar 430 or progress bar 435 can be displayed by hovering a computer cursor over each bar.

FIG. 5 is a screenshot of the textual summary of the lesson list 500 associated with the corresponding standards as generated in step 100. Lesson list 500 shows a textual list of the various standards grouped by lesson. This lesson list 500 is useful to give the user an explanation of each standard applied to the lessons. This helps users ensure they cover the essential topics of the lesson. Tabs 510 are used to switch between classes. Lesson heading 520 identifies each lesson, and standards are grouped underneath them with a label 525 and a definition 527. Above the lesson list is the set of controls 530 for navigation between views and the performance of other functions as described above.

FIG. 12 is a screenshot of a Associated Standards dialog box 1200 that is accessible from the “Standards” pull-down menu at the top of each of the graphical summary view 400 and the textual summary 500. The Associated Standards dialog box 1200 contains a list of all the standards 1205 that have been applied to the current class. Double-clicking on any text of an item in list 1205 allows the user to edit the text for the associate standard. In the dialog box 1200 the user can also remove standards from the course curriculum. Clicking on the “Remove” button 1210 removes the currently highlighted standard from the class.

The user can also add standards to a class. By clicking on the “Add Custom Standard” menu 1215, the user can add a new standard to the bottom of list 1205. The user can then edit the text of that standard by double clicking on it as described above. This function is particularly useful when state education departments do not have a preset list of educational standards for teachers to adhere to. The teacher can decide upon a proper curriculum and add the standards themselves.

If a list of pre-loaded standards is available to draw from (such as a state-provided list of educational standards), the user can click on the “Add Preloaded Standard” menu 1220. The program displays a navigational interface 1223 and a list 1225 of pre-loaded standard. By checking the appropriate checkboxes on the navigational interface, the user can search for standards that fit the standards selected. For example, checking the “PA” box will display only the standards that are provided by the Pennsylvania Department of Education.). Interface 1223 preferably has checkboxes corresponding to several search standards such as State, Subject, Year, and Grade Level. It also allows users to include a filter, utilizing a real-time search to filter out any standards that do not match the character string entered into Filter Code box 1230. The user can also highlight one, some, or all (by clicking select all standards button 1230) standards displayed in list 1225 and add them to the class by clicking the “Add Selected Standard(s)” button 1235.

While the described system has been presented in this specification in an educational context, its embodiments are applicable to other areas. The system could be used for business management, medical systems, etc. In addition, the example screenshots provided could be modified for ease of use or to afford more powerful features to be included in the software. The specific examples of systems, users, and interfaces are exemplary, and in no way impose limitations on the invention as described.

1. A computer program product, comprising a computer usable medium having a computer readable program code embodied therein, said computer readable program code adapted to be executed to implement a method for organizing computer files, said method comprising the steps of:
generating a matrix of cells to be displayed to the user;
displaying said matrix on a computer screen to a user;
allowing the user to associate computer files with respective ones of said cells;
creating a file structure based on the computer files associated with said cells;
storing copies of said computer files within said structure; and
providing access to said files through the program.

2. The product of claim 1, wherein the method comprises the step of allowing the user to associate computer files with said cells includes the step of accepting a file that has been dragged from a computer folder and dropped in one of said cells when said matrix is displayed.

3. The product of claim 1, wherein the method further comprises the step of displaying in said matrix indicia of the status of the computer files to the user.

4. The product of claim 1, wherein the method further comprises the step of displaying a dialog box on the computer screen to obtain information from the user for initial setup of the matrix.

5. The product of claim 1, wherein the method further comprises the step of displaying a calendar interface to the user.

6. The product of claim 1, wherein the method further comprises the step of associating the date and time of utilization of saved documents with the corresponding copies of the document files associated with each of said cells.

7. The product of claim 1, wherein the method further comprises the step of creating a report on the status of the document files associated with the cells of said matrix.

8. (canceled)

9. The product of claim 1, wherein the method comprises the step of generating indicia that identify any cells that do not have files associated with them.

10. The product of claim 1, wherein the method comprises the steps of providing a template for said matrix and automatically creating the file structure based on said template.

11. The method product of claim 1, wherein the file structure comprises a folder tree, with folders corresponding to the x-y coordinates of each cell on the matrix.

12. The product of claim 1, wherein the file structure comprises a database file.

13. The product of claim 1, wherein the the method comprises the steps of:
setting up a project plan comprising one or more standardized objectives,
associating one or more cells of the matrix with each of said standardized objectives, and then
evaluating the status of the objectives based on the utilization of documents associated with the cells of the matrix.

14. (canceled)

15. A method of organizing, managing, and using document files on a computer comprising the steps of:
creating a matrix of cells having row headers and column headers;
displaying said matrix on a computer screen to a user;
associating a document file with a cell of the matrix;
creating a file structure that defines a link between the document file and the associated cell of the matrix;
storing an electronic copy of the document file within the file structure;
accessing the document file by selecting the cell that is associated with the desired document file; and then
displaying the document to the user on the computer screen.

16. A method as claimed in claim 15 wherein the step of creating the matrix comprises the steps of:
creating a title for display with the matrix;
selecting the number of rows and columns to be displayed in the matrix;
creating descriptions of topics to be displayed with each row of the matrix;
creating descriptions of documents to be displayed with each column of the matrix; and
associating a standardized objective with each of the rows for display in the matrix.

17. A method as claimed in claim 15 wherein the step of associating a document file with a cell comprises the steps of dragging a file from a computer folder on the computer screen to the desired matrix cell displayed on the computer screen and then dropping the file into the cell.

18. A method as claimed in claim 15 comprising the steps of:
generating indicia representing the status of a document associated with a matrix cell; and then
displaying the matrix on the computer screen with the indicia associated with the matrix cell.

19. A method as claimed in claim 18 wherein the indicia comprises a date when the document was used or a task associated with the document was completed.

20. A method as claimed in claim 19 comprising the steps of:
generating a calendar associated with the matrix;
associating date indicia from the matrix with a corresponding date in the calendar; and then
displaying the calendar on the computer screen with the date indicia from the matrix.

21. The method of claim 15, wherein the comprising the steps of
setting up a project plan comprising one or more standardized objectives,
associating one or more cells of the matrix with each of said standardized objectives, and then
evaluating the status of the objectives based on the utilization of documents associated with the associated cells of the matrix.

22. The method of claim 18 wherein the indicia comprises the color of a matrix cell to be displayed to the user.
